(19) United States
(12) Patent Application Publication
(10) Pub. No.: US 2015/0178367 A1
(43) Pub. Date: Jun. 25, 2015

(54) SYSTEM AND METHOD FOR IMPLEMENTING ONLINE ANALYTICAL PROCESSING (OLAP) SOLUTION USING MAPREDUCE

(71) Applicant: Infosys Limited, Bangalore (IN)

(72) Inventors: Shyam Kumar Doddavula, Bangalore (IN); Arun Viswanathan, Bangalore (IN)

(21) Appl. No.: 14/559,642

(22) Filed: Dec. 3, 2014

(30) Foreign Application Priority Data
Dec. 20, 2013 (IN) 5996/CHE/2013

(51) Int. Cl. G06F 17/30

(52) U.S. Cl. CPC G06F 17/30592; G06F 17/30563; G06F 17/30106

(57) ABSTRACT

The technique relates to a system and method for implementing petabyte scale online analytical processing solutions using MapReduce. The technique involves receiving an OLAP query from a user through an OLAP-QL Driver. After receiving the query it is parsed through the compiler. Then the metadata information is retrieved from the parsed query through the metadata manager. Validating the parsed query using plan generator module for generating a MapReduce job execution plan based on the retrieved metadata information. The next step is to identify the scope for optimization in the generated MapReduce job execution plan and optimizing the MapReduce job execution plan using the identified scope. Then executing the optimized MapReduce job plan using the execution engine and finally storing the output data in the cube specific distributed file system directory.

This application claims the benefit of Indian Patent Application No. 5996/CHE/2013 filed Dec. 20, 2013, which is hereby incorporated by reference in its entirety.

### FIELD OF THE INVENTION

The present invention relates generally to online analytical processing and in particular, to a system and method for implementing peta-byte scale online analytical processing solution using MapReduce

### BACKGROUND

Digitization of various business functions and adoption of digital channels by the consumers has been resulting in a deluge of information. This is resulting in huge volumes of data getting generated at increasing pace and in various forms and varieties. The data volumes are increasing exponentially especially the unstructured data. Organizations are now dealing with Big Data that are in Petabytes or more with a periodic increase in terms of Terabytes of data. These large datasets are beyond the ability of traditional software tools to capture, store and process them. Thus a whole new set of Big Data technologies like MapReduce, NoSQL solutions, etc. have emerged that enable storage and processing of data at higher order of magnitude at much lower costs than what was possible with traditional technologies.

Analytics and Reporting solutions help analyze the data and generate reports to be consumed by the business users. An OLAP solution is used to creating cubes in a relational database which is then used to generate reports. These solutions work well on structured data. But they would be unable to handle unstructured or semi-structured data. A lot of data that has information about customer behavior like the customer click stream data in web logs are not being captured or analyzed currently for mining customer preferences. OLAP Solutions also become expensive with large datasets. Big Data technologies are helping reduce the costs while scaling to petabytes of data and handling unstructured data thus resulting in significant innovations in Business Intelligence (BI) and Analytics. There is a requirement for an OLAP Solution that stores and processes Petabyte datasets and can help organizations gain a more detailed insight into their problems. Big Data frameworks like Hadoop are being used to store and combine structured, semi-structured and unstructured data from multiple sources. The data is processed and analyzed using MapReduce programs to derive some useful business insights.

Big Data Analytics has been applied in organization cutting verticals for real-world problems. Some sample use cases where a Petabyte OLAP Solution will be applicable is for Sentiment Analysis wherein the unstructured social media content and social networking posts can be used to determine the user sentiment related to particular companies, brands or products. Analysis can focus on macro-level sentiment down to individual user sentiment. The next segment would be Fraud Detection where Identifying and flagging a fraudulent activity based on data from multiple sources including customer behavior, historical and transactional data is a scenario that online payment companies are using. Then it is followed by Customer Churn Analysis that uses Big Data technologies, organizations analyze customer behavior data to identify customer behavior patterns. Based on the behavior patterns, customers who are most likely to leave for a competing vendor or service can be identified.

The key challenge is with storing and processing large volumes of data efficiently. Traditional enterprise data warehouse and analytics solutions use expensive hardware and also cannot scale to petabytes of data. Another challenge is ease-of-use in providing an interface that will allow business users to run OLAP queries on a large dataset that is stored over a distributed file system. Writing and executing MapReduce jobs requires additional skillset of knowing a programming or scripting language and so is difficult for business analysts to use. Traditional OLAP solutions support a number of OLAP query interfaces that provide a wide variety of aggregation and analytical functionalities. There is a need for such OLAP query interfaces to be developed over MapReduce solutions.

Traditional Online Analytical Processing solutions (OLAP) use relational databases to store and process data. A number of OLAP solutions are available in the market such as Microsoft Analysis Services, Oracle Essbase, MicroStrategy, Mondrian, SAS, etc. These solutions support using query languages such as MDX, XML for Analysis, OLE DB for OLAP or SQL that process data stored in relational databases.

These solutions have the limitation in that they cannot scale horizontally using commodity hardware to be able to address the needs of next generation Big Data scenarios involving petabytes of data. Hadoop provides a solution for leveraging commodity hardware to scale horizontally but it has the limitation that it is difficult to use for business analysts as it doesn't offer the needed abstractions for business analysts. Hadoop needs developers to create MapReduce jobs and so is not easy to use for business analysts who do not have programming skills.

All the above stated methods describe different methods of parsing a SQL-like query string into MapReduce jobs. Some of them support specific aggregation functions on the data set. They however do not support the needs of online Analytical Processing (OLAP) as the data models (cubes, dimensions, etc.) is different and the kind of OLAP operations like aggregation and analytical functions to be applied are different. Analytical processing can also involve applying complex machine learning algorithms so SQL based solutions are inadequate.

### SUMMARY

The present technique online analytical processing solution overcomes the above mentioned limitation by implementing an OLAP solution that translates an OLAP QL into one or more MapReduce jobs and executes them on a dataset stored in a distributed file system such as HDFS.

According to one embodiment of the present disclosure, a method for implementing Online Analytical Processing (OLAP) solution using Map Reduce is disclosed. The technique involves receiving an OLAP query from a user through an OLAP-QL Driver. After receiving the query it is parsed through the compiler. Then the metadata information is retrieved from the parsed query through the metadata manager. Validating the parsed query using plan generator module for generating a MapReduce job execution plan based on the retrieved metadata information. The next step is to identify the scope for optimization in the generated MapReduce job execution plan and optimizing the MapReduce job execution plan using the identified scope. Then executing the optimized MapReduce job plan using the execution engine and finally storing the output data in the cube specific distributed file system directory.

In an additional embodiment, a system for implementing Online Analytical Processing (OLAP) solution using Map Reduce is disclosed. The system includes a receiving module, a parsing module, a retrieving module, a validation module, an identification module, an execution module and a storage module. The receiving module is configured to receive input OLAP query from a user. A parsing module is configured to parse the received input query. The retrieving module is configured to retrieve the metadata information from the parsed OLAP query through the metadata manager. The validation module for validating the OLAP query and generating a MapReduce job execution plan based on the retrieved metadata information. An identification module configured for identifying the scope for optimization in the generated MapReduce job execution plan and optimizing the MapReduce job execution plan using the identified scope. An execution module is configured to execute the optimized MapReduce job execution plan using an execution engine and a storage module for storing the output data in a cube specific distributed file system (DFS) directory.

In another embodiment, a computer readable storage medium for implementing online Analytical Processing (OLAP) solution using Map Reduce is disclosed. The computer readable storage medium which is not a signal stores computer executable instructions for capturing an OLAP query from the user through an OLAP-QL driver, parsing the OLAP query, for retrieving metadata information of the OLAP query through a meta date manager, validating the OLAP query and generating a MapReduce Job execution plan based on the retrieved metadata information of the OLAP query, identifying the scope for optimization in the generated MapReduce job execution plan and optimizing the MapReduce job execution plan using the identified scope, executing the optimized MapReduce job execution plan using an execution engine and storing the output data in a cube specific distributed file system (DFS) directory.

### DRAWINGS

Various embodiments of the technology will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein;

FIG. 2 is a block diagram illustrating the steps for implementing OLAP solution using MapReduce.

FIG. 3 is an architecture diagram illustrating a method for implementing OLAP solution using MapReduce.

FIG. 4 is a flowchart diagram illustrating the steps for generating the MapReduce job plan for executing the OLAP query.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present technique provide a system and method for implementing Online Analytical Processing (OLAP) solution using Map Reduce. This involves receiving the OLAP query from a user through an OLAP-QL Driver. The received query is parsed as the next step. Then the metadata information is received from the parsed OLAP query using the metadata manager. Then validating the parsed OLAP query using a plan generator module for generating a MapReduce Job execution plan based on the retrieved metadata information. As the next step identifying a scope for optimization in the generated MapReduce job execution plan using an optimizer and optimizing the MapReduce job execution plan using the identified scope. Thereafter, executing the optimized MapReduce job execution plan using an execution engine. Finally, storing the output data in a cube specific distributed file system (DFS) directory.

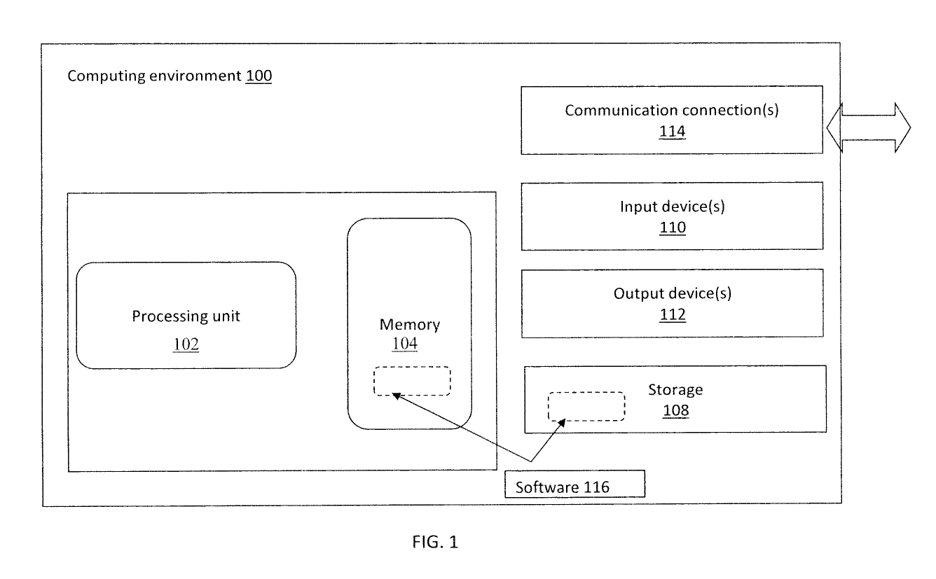

FIG. 1 illustrates an example of a suitable computing environment 100 in which all embodiments and techniques of this technology may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one input unit 100 central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

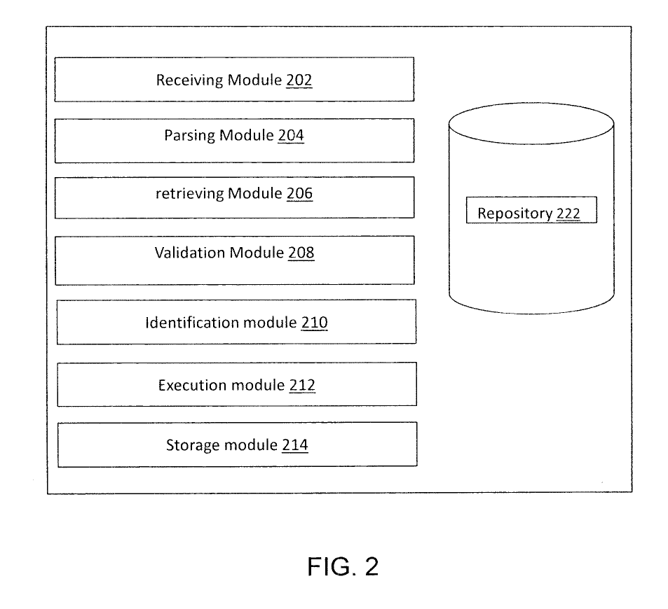

FIG. 2 is block diagram illustrating a system for implementing Online Analytical Processing (OLAP) solution using Map reduce technique, in accordance with an embodiment of the present technology. More particularly, the system includes a receiving module 202, a parsing module 204, a retrieving module 206, a validation module 208, an identification module 210, an execution module 212 and the storage module 214. The receiving module 202 is configured to capture the user input of OLAP query. The parsing module 204 is configured to parse the received OLAP query. The retrieving module 206 is configured to retrieve the metadata information of the parsed OLAP query through a metadata manager. A validation module 208 is configured to validate the retrieved OLAP query and to generate a MapReduce Job execution plan based on the retrieved metadata information. The identification module 210 is used for identifying the scope for optimization in the generated MapReduce job execution plan and optimizing the MapReduce job execution plan using the identified scope. The execution module 212 is used for executing the optimized MapReduce job execution plan using an execution engine. The storage module 214 is used for storing the output data in a cube specific distributed file system (DFS) directory.

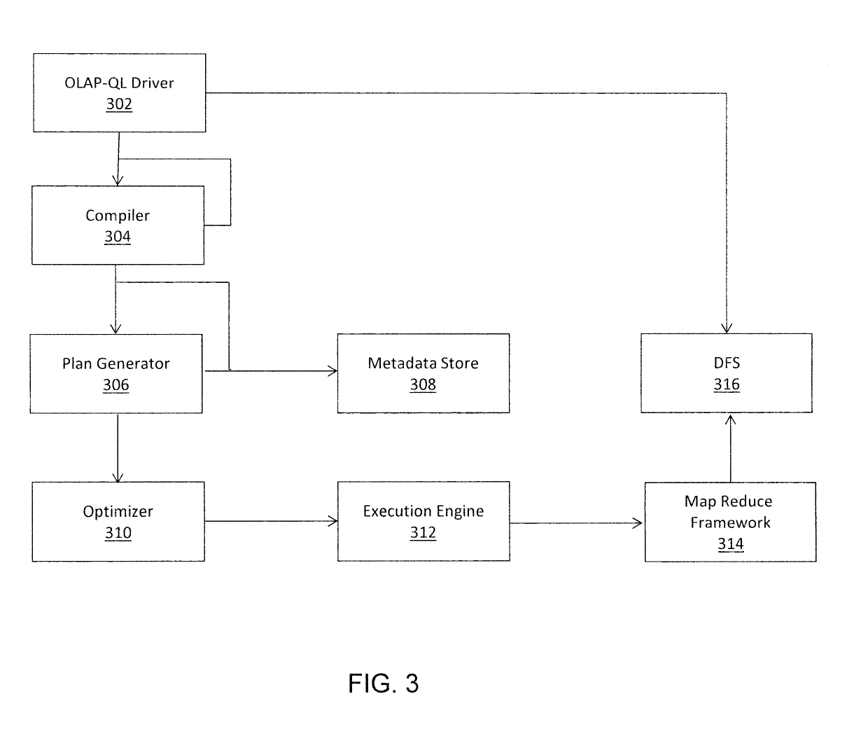

FIG. 3 is an architectural diagram, illustrating a method for implementing Online Analytical Processing (OLAP) solution using Map reduce technique, in accordance with an embodiment of the present technology. The user input on OLAP query is captured as in step 302. The sample query languages for OLAP could include Multi-dimensional Expressions (MDX), Data Mining Extensions (DMX) or XML for Analysis (XMLA).

The compiler 304 can be plugged in for parsing each of the OLAP query languages. Then it validates the query for the correct syntax. As the next step, it retrieves the required cube schema information from the query. The information retrieved includes Fact name, Dimension names, Measures, Aggregation functions, Analytical functions and other axis details.

Plan generator 306 is used for receiving the parsed query with the retrieved cube schema details for generating an execution plan with one or more MapReduce jobs. The metadata store 308 is used to store the metadata schema information. The plan generator 306 retrieves the metadata schema information of the cube from the metadata store 308. The metadata store 308 could be a file system or a database. The following table illustrates the representative cube metadata with information related to the fact, dimensions, measures and functions.

| Cube | Dimensions | Measures |
|---|---|---|
| Cube_ID | Cube_ID | Cube_ID |
| Cube_Name | Dimension_ID | Measure_ID |
| Create_Time | Dimension_Value | Measure_Value |
| Comments | Dimension_Axis | Measure_Axis |
| Owner | Dimension_Expression | Measure_Aggregation |
| | | Measure_Expression |

| Cube_Details | Dimension_Details | Measure_Details |
|---|---|---|
| Cube_ID | Dimension_ID | Measure_ID |
| Row_Format | Dimension_Name | Measure_Name |
| File_Format | Dimension_Type | Measure_Type |
| Compression | | |
| Dir_Location | | |
| Serializer_ID | | |
| Sort_Col_ID | | |
| Cube_Dir_Location | | |

| Fact | Dimension_Level | Functions |
|---|---|---|
| Cube_ID | Dimension_ID | Cube_ID |
| Fact_ID | Level_ID | Fuction_ID |
| Fact_Dir_Location | Hierarchy | Function_Name |
| | Level_Order | Function_Impl |
| | Level_Name | Function_Impl_Location |
| | Level_Type | |
| | Dimension_Expres- | |
| | sion | |
| Serializer | Sort_Attributes | Function_Params |
| Serializer_ID | Sort_Col_ID | Function_ID |
| Serializer_Impl | Sort_Col_Name | Function_Param_Name |
| | Sort_Order | Function_Param_Value |

Consider that the Home directory of the OLAP is /olap. The metadata store 308 will contain the above mentioned metadata details for accessing the entities and cubes. Each Fact entity, dimension entity and cube is represented by a directory location in the datastore. The datastore will contain the content of the entity and cubes in the form of uncompressed or compressed text files. Thee optimizer 310 is used to identify the optimization options in the MapReduce jobs. The plan generated in 306 is run through optimizer 310 to check for opportunities to tweak the jobs for better performance and faster results. Optimization options could include choosing relevant attributes while fetching data, re-ordering the entities while fetching, optimization of joins, adding or removing jobs for performance enhancements etc. One of the techniques for the optimization of joins is generation of hash using techniques like bloom filter in map side and using that to filter only data that is relevant for further processing through join. Based on the optimizations identified in the earlier steps, an update job execution plan is generated. The optimized job plan is sent to the

Execution Engine 312 which uses the MapReduce framework for executing the jobs. The Execution Engine 312 sits on top of the MapReduce Framework 312 which receives the update job execution plan. Based on the plan, the framework spawns off the mappers and reducers on the dataset. The Distributed File System (DFS) 316 is used to store the output of the MapReduce jobs and provide the results to the user.

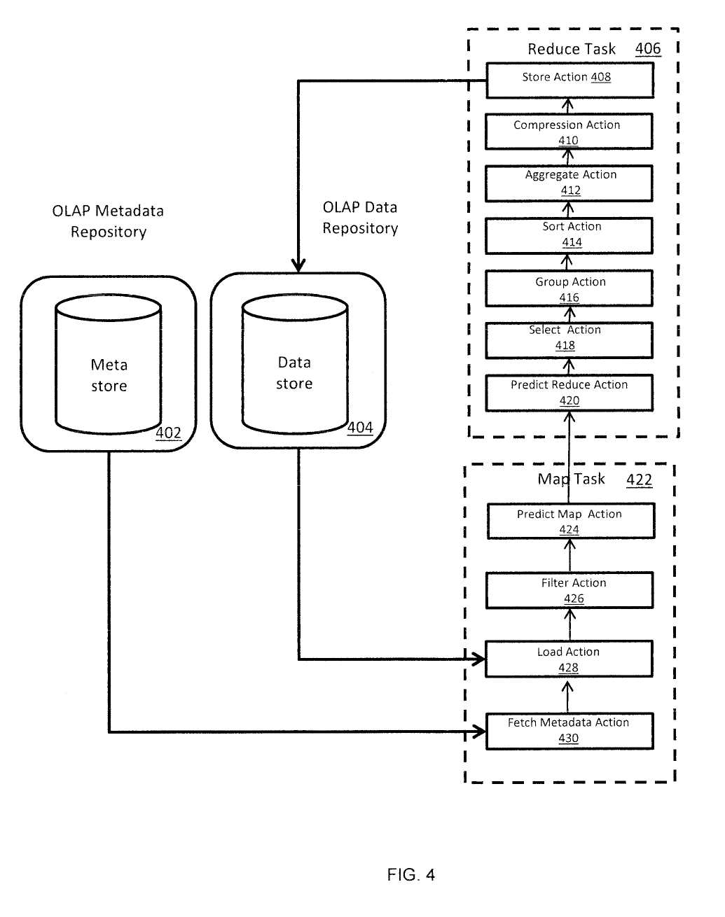

FIG. 4 is a flowchart diagram illustrating the steps for generating the MapReduce job plan for executing the OLAP query. The plan generator component 306 in FIG. 3 will generate the plan that consists of a directed acyclic graph of actions to be executed as MapReduce jobs required to implement the OLAP query. A number of actions are pre-defined and they can also be user-defined and plugged into the framework. The OLAP query will be mapped to these pre-defined actions and MapReduce jobs would be defined whose task includes executing one or more of these actions. The job plan could include one or more MapReduce jobs chained together to process the dataset sequentially or in parallel order. A representative set of pre-defined actions for performing pre-defined functionality could be implemented using a programming language such as Java. These functionalities would then be called from one or more Map/Reduce tasks.

The StoreAction 408 is used to store data into a particular directory location. For e.g. the final Cube output is stored in the cube directory location using this command The CompressAction 410 is used to compress the data into a user-specified format based on the compress algorithm defined in the DFS. The AggregateAction 412 is used to perform aggregations on a measure in the given dataset. The functions supported are sum, count, average, min, max etc. The SortAction 414 is used to provide a sorted dataset ordered by one or more attributes in ascending or descending. The GroupAction 416 is used to group the output dataset based on the attributes specified. The SelectAction 418 is used to select specific attributes of a fact or dimension of a cub for further processing. The PredictAction is used for applying predictive analysis to predict the data. It is split into a PredictMapAction 424 and PredictReduceAction 420.

The FilterAction 426 is used to perform a filtering action based on one or more attributes in the given entity dataset. The LoadAction 428 is used to read data from a particular directory location. It is used to scan the fact entity and each of the specified dimension entities from the DFS. For e.g. the fact entities and dimension entity data is loaded from the text files in the respective directory location. The FetchMetaDataAction 430 is used to retrieve the metadata information for a given entity such as cube, fact or dimension from the metastore. The metadata information would be located in a file system or a database.

The above mentioned description is presented to enable a person of ordinary skill in the art to make and use the technology and is provided in the context of the requirement for obtaining a patent. Various modifications to the preferred embodiment will be readily apparent to those skilled in the art and the generic principles of the present technology may be applied to other embodiments, and some features of the present technology may be used without the corresponding use of other features. Accordingly, the present invention is not intended to be limited to the embodiments shown but is to be accorded the widest scope consistent with the principles and features described herein.

We claim:

1. A method for implementing an Online Analytical Processing (OLAP) solution using Map Reduce, the method comprising:
parsing, by the OLAP processing computing system, a received OLAP query;
retrieving, by the OLAP processing computing system, metadata information from the parsed OLAP query;
validating, by the OLAP processing computing system, the parsed OLAP query and generating a MapReduce job execution plan based on the retrieved metadata information;
identifying, by the OLAP processing computing system, a scope for optimization in the generated MapReduce job execution plan and optimizing the MapReduce job execution plan using the identified scope;
executing, by the OLAP processing computing system, the optimized MapReduce job execution plan; and
storing, by the OLAP processing computing system, data output as a result of the execution in a cube specific distributed file system (DFS) directory.

2. The method as claimed in claim 1, wherein the validating further comprises compiler validates the OLAP query for correct syntax.

3. The method as claimed in claim 1, wherein the retrieved metadata information comprises cube schema information comprises a fact name, a dimension name, a measure, an aggregation function, an analytical function or other axis details from the received OLAP query.

4. The method as claimed in claim 1, wherein the optimizing further comprises:
identifying relevant attributes in the retrieved metadata information;
re-ordering one or more entities in the retrieved metadata information;
optimizing one or more joins using a map side bloom filter; and
rearranging the order of execution of one or more tasks across multiple jobs.

5. A Online Analytical Processing (OLAP) processing computing system, comprising a processor and a memory coupled to the processor which is configured to be capable of executing programmed instructions comprising and stored in the memory to:
parse a received OLAP query;
retrieve metadata information from the parsed OLAP query;
validate the parsed OLAP query and generating a MapReduce job execution plan based on the retrieved metadata information;
identify a scope for optimization in the generated MapReduce job execution plan and optimizing the MapReduce job execution plan using the identified scope;
execute the optimized MapReduce job execution plan; and
store data output as a result of the execution in a cube specific distributed file system (DFS) directory.

6. The system as claimed in claim 5, wherein the validating further comprises compiler validates the OLAP query for correct syntax.

7. The system as claimed in claim 5, wherein the retrieved metadata information comprises cube schema information comprises a fact name, a dimension name, a measure, an aggregation function, an analytical function or other axis details from the received OLAP query.

8. The system as claimed in claim 5, wherein the processor coupled to the memory is further configured to be capable of executing additional programmed instructions comprising and stored in the memory to:
identify relevant attributes in the retrieved metadata information;
re-order one or more entities in the retrieved metadata information;
optimize one or more joins using a map side bloom filter; and
rearrange the order of execution of one or more tasks across multiple jobs.

9. A non-transitory computer readable medium having stored thereon instructions for implementing an Online Analytical Processing (OLAP) solution using Map Reduce comprising executable code which when executed by a processor, causes the processor to perform steps comprising:
parsing a received OLAP query;
retrieving metadata information from the parsed OLAP query;
validating the parsed OLAP query and generating a MapReduce job execution plan based on the retrieved metadata information;
identifying a scope for optimization in the generated MapReduce job execution plan and optimizing the MapReduce job execution plan using the identified scope;
executing the optimized MapReduce job execution plan; and
storing data output as a result of the execution in a cube specific distributed file system (DFS) directory.

10. The non-transitory computer readable medium as claimed in claim 9, wherein the validating further comprises compiler validates the OLAP query for correct syntax.

11. The non-transitory computer readable medium as claimed in claim 9, wherein the retrieved metadata information comprises cube schema information comprises a fact name, a dimension name, a measure, an aggregation function, an analytical function or other axis details from the received OLAP query.

12. The non-transitory computer readable medium as claimed in claim 9, wherein the optimizing further comprises:
identifying relevant attributes in the retrieved metadata information;
re-ordering one or more entities in the retrieved metadata information;
optimizing one or more joins using a map side bloom filter; and
rearranging the order of execution of one or more tasks across multiple jobs.
